(19) United States
(12) Patent Application Publication
(10) Pub. No.: US 2026/0230023 A1
(43) Pub. Date: Aug. 6, 2026

(54) CONTROL CONCEPT FOR LINEAR ELECTRIC DRIVE CONVEYOR

(71) Applicant: KRONES AG, Neutraubling (DE)

(72) Inventors: Thomas KIENDL, Maxhuette-Haidhof (DE); Martin KAMMERL, Hemau (DE)

(21) Appl. No.: 18/842,507

(22) PCT Filed: Mar. 9, 2023
(86) PCT No.: PCT/EP2023/056019

§ 371 Date: Aug. 29, 2024

(30) Foreign Application Priority Data
Mar. 11, 2022 (DE) 10 2022 105 731.3

(51) Int. Cl. H02P 25/064; B65G 54/02; G05B 17/02

(52) U.S. Cl. CPC H02P 25/064; B65G 54/02; G05B 17/02

(57) ABSTRACT

The invention relates inter alia to a method for operating a linear electric drive conveyor. The method comprises creating a virtual movement path for each model object in a virtual model that represents the linear electric drive conveyor. The method further comprises controlling the linear electric drive conveyor in order to move a first moving device and a second moving device, per group, along a static part of the linear electric drive conveyor according to the virtual movement path of the respective model object that represents the respective group.

### TECHNICAL FIELD

The invention relates to a method for operating a linear electric drive conveyor. The invention further relates to a linear electric drive conveyor. The invention further relates to an industrial system having a linear electric drive conveyor.

### TECHNICAL BACKGROUND

A current development trend in the transport of containers, such as bottles or cans, in systems and machines for the production, filling and packaging of beverages and liquid foods is linear motor technology, e.g., in the form of long-stator linear drive systems or short-stator linear drive systems. The moving devices, also known as “shuttles” or “movers,” can each move one or more containers. A major advantage of linear motor technology is that the moving devices can be controlled and moved individually or separately and independently of one another.

EP 3 045 399 A1 discloses a group of movers (moving devices) consisting of two movers that jointly transport a container. The container is held between the shoulders of two pockets, which are each fastened to the two movers. The free distance between the two movers determines a distance between the two shoulders that is equal to the length of the container.

A disadvantage of the conventional state of the art can be that control of the moving devices in systems in which several moving devices jointly transport one transport item is challenging, complex in terms of control technology and difficult to maintain. A particularly large amount of effort can arise, for example, in particular if a change in the control technology of the items to be transported is to be implemented.

The invention is based on the object of providing simple and/or improved control for a linear electric drive conveyor for transporting transport items.

### SUMMARY OF THE INVENTION

The object is achieved by the features of the independent claims. Advantageous developments are specified in the dependent claims and the description.

One aspect of the present disclosure relates to a method for operating a linear electric drive conveyor (e.g., an industrial system or a container treatment system) having multiple electromagnetically and independently movable moving devices which are combined into multiple groups (e.g., first group and second group) (or which form multiple groups). The multiple moving devices per group are movable in order to jointly transport a transport item (e.g., having one or more objects or containers) which is preferably clamped between them or held together. The method comprises creating a virtual movement path for each model object (e.g., first model object and second model object) in a virtual model that represents the linear electric drive conveyor. In the virtual model, each group is represented by a model object. The created virtual movement paths each indicate a time-dependent position progression of the respective model object along a static part of the virtual model. The method further comprises controlling the linear electric drive conveyor in order to move a first moving device and a second moving device, per group, along a static part of the linear electric drive conveyor according to, preferably coupled or co-moving with, the virtual movement path of the model object that represents the respective group.

Advantageously, the method can simplify control of the linear electric drive conveyor. In particular, settings can be configured very quickly and easily, as all moving devices in a group depend on a single (virtual) movement path. By changing this virtual movement path, changes can therefore be made directly in the real movement paths of all moving devices in the respective group. It is therefore no longer necessary to create a separate and adjusted movement path for each individual moving device in the group. This can also make the conveyor easier to maintain. In addition, adjustments and changes can be easily implemented if, for example, other transport items need to be transported. For example, the virtual movement path for each model object can remain unchanged. Only the dependency of the movement of the moving devices for each group on this virtual movement path needs to be adjusted, e.g., to the changed size of the transport object.

Preferably, electromagnets of the linear electric drive conveyor can be controlled during control of the linear electric drive conveyor.

For example, the movements of the first and second moving devices in each group can be directly dependent on the virtual movement path of the model object that represents the respective group. However, it is also possible that, for example, as an intermediate step for the first moving device and the second moving device in each group, a separate movement path is derived from the virtual movement path of the model object that represents the respective group, and the first moving device and the second moving device in each group are moved according to the derived separate movement path.

In one exemplary embodiment, the linear electric drive conveyor is controlled in such a way that the first moving device in each group moves synchronously, preferably in advance, at least temporarily at a first distance from the virtual movement path of the model object representing the respective group. Alternatively or additionally, the linear electric drive conveyor is controlled in such a way that the second moving device in each group moves synchronously, preferably follows, at least temporarily at a second distance from the virtual movement path of the model object representing the respective group. Advantageously, this means that adjustment to other transport items can be implemented very easily during a changeover, as only the distances need to be adjusted to the dimensions of the transport item to be transported after the changeover.

In a further exemplary embodiment, the method further comprises specifying the first distance and/or the second distance, preferably by means of a user interface. Advantageously, the adjustment can thus be carried out very easily by the user.

In a further exemplary embodiment, the first distance and/or the second distance is specified depending on a size of the transport item. Preferably, the larger the transport item, the larger the specified first distance and/or the second distance can be. Alternatively or additionally, for example, a sum of the first distance and the second distance may correspond substantially to a width of the transport item or substantially to a diameter of the transport item.

In a further exemplary embodiment, the method further comprises selecting the transport item from a selection of transport items of different sizes. Preferably, the first distance and/or the second distance can be specified depending on a size of the selected transport item.

In one embodiment, the method further comprises changing the first distance and/or the second distance when changing the transport item format, preferably when changing the container format.

In a further embodiment, the method further comprises temporarily overriding the first distance and/or the second distance in order to effect a relative movement between the first moving device and the second moving device per group, preferably in order to take over the transport item, hold the transport item, clamp the transport item, transfer the transport item and/or release the transport item. Advantageously, the temporary overriding can be used to implement additional functions of the conveyor in a very simple way.

In a further embodiment, the temporary overriding of the first distance and/or of the second distance is dependent on a variable parameter value, preferably size parameter value, of the model object that represents the respective group. Preferably, the variable parameter value can be greater before the transport item is clamped than when it is being clamped, the variable parameter value can be reduced to clamp the transport item, the variable parameter value can be increased to release the transport item and/or the variable parameter value can be greater when the transport item is being released than when it is being clamped. In this way, it can additionally be advantageously ensured that the parameter value of the model object can already prevent a collision of the moving devices in each group.

Preferably, the parameter value can change along the virtual movement path.

Preferably, a change in the parameter value along the virtual movement path can be specified, preferably by means of a user interface.

In one embodiment variant, the method further comprises setting one of the first distance and the second distance to a constant value. Preferably, the method may further comprise temporarily overriding the other of the first distance and the second distance with a force-controlled movement of the respective moving device (e.g., the moving device whose distance, i.e. first or second distance, is overridden) in order to clamp the transport item between the first moving device and the second moving device. Advantageously, a holding function for the transport item can be implemented very easily in this way.

In a further embodiment variant, the linear electric drive conveyor is controlled in such a way that the first moving device and the second moving device, per group, move along the static part of the linear electric drive conveyor at least temporarily while performing a relative movement to one another for clamping, holding and/or releasing the transport item with the virtual movement path of the model object that represents the respective group.

In a further embodiment variant, the method further comprises controlling the linear electric drive conveyor in order to move a third moving device, per group, along the static part of the linear electric drive conveyor according to, preferably coupled or co-moving with, the virtual movement path of the model object that represents the respective group. Advantageously, the control concept can be used for different group sizes due to its functional encapsulation and can be very easily adjusted to different group sizes. Advantageously, this can reduce the testing effort for new applications in particular.

Preferably, the features mentioned with respect to the first moving device and the second moving device can also be applied to the third moving device per group, e.g., third distance, etc.

In one exemplary embodiment, the virtual movement path has, for each model object, a path section which extends from a transport item takeover point for taking over the transport item to a transport item transfer point for transferring the transport item.

In a further exemplary embodiment, the linear electric drive conveyor is a long-stator linear drive conveyor, a short-stator linear drive conveyor or a planar linear drive conveyor.

A further aspect of the present disclosure relates to a linear electric drive conveyor for an industrial system, preferably a container treatment system. The linear electric drive conveyor has multiple electromagnetically and independently movable moving devices, which are combined or can be combined into multiple groups. The multiple moving devices per group are movable in order to jointly transport a transport item (e.g., having one or more objects or containers) which is preferably clamped between them or held together. The linear electric drive conveyor comprises a control unit configured to carry out a method as disclosed herein. Advantageously, the linear electric drive conveyor can be used to achieve the same advantages already described with reference to the method.

A further aspect of the present disclosure relates to an industrial system, preferably a container treatment system. The industrial system comprises a linear electric drive conveyor as disclosed herein.

Preferably, the container treatment system is designed for manufacturing, cleaning, coating, checking, filling, closing, labeling, printing, and/or packaging containers for liquid media, preferably beverages or liquid foods.

Preferably, the transport items can be designed as containers. For example, the containers can be configured as bottles, cans, canisters, cartons, vials, etc.

Preferably, the term “control unit” can refer to an electronic system (e.g., with microprocessor(s) and data memory) that can perform control tasks and/or regulating tasks and/or processing tasks depending on the configuration. Although the term “control” is used herein, this can also comprise or be understood as “regulate” or “feedback-control” and/or “process.”

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 shows a schematic representation of a linear electric drive conveyor for transporting transport items;

FIG. 2 shows a schematic representation of multiple movement paths of the moving devices of the conveyor from FIG. 1;

FIG. 3 shows a schematic representation of a linear electric drive conveyor for transporting transport items;

FIG. 4 shows a schematic representation of multiple movement paths of the moving devices of the conveyor from FIG. 3;

FIG. 5 shows a schematic representation of a linear electric drive conveyor according to an exemplary embodiment of the present disclosure;

FIG. 6 shows a virtual model of the linear electric drive conveyor of FIG. 5 according to an exemplary embodiment of the present disclosure;

FIG. 7 shows a schematic representation of multiple virtual movement paths of multiple model objects of the virtual model from FIG. 6 according to an exemplary embodiment of the present disclosure;

FIG. 8 shows a schematic representation of a movement of multiple moving devices relative to one of the virtual movement paths of FIG. 7 according to an exemplary embodiment of the present disclosure;

FIG. 9 shows a schematic representation of a control system of multiple moving devices for transporting a transport item according to an exemplary embodiment of the present disclosure; and

FIG. 10 shows a schematic representation of embodiment variants of a linear electric drive conveyor for applying the techniques of the present disclosure:

The embodiments shown in the drawings correspond at least in part, so that similar or identical parts are provided with the same reference signs and reference is also made to the description of other embodiments or figures for the explanation thereof to avoid repetition.

### DETAILED DESCRIPTION

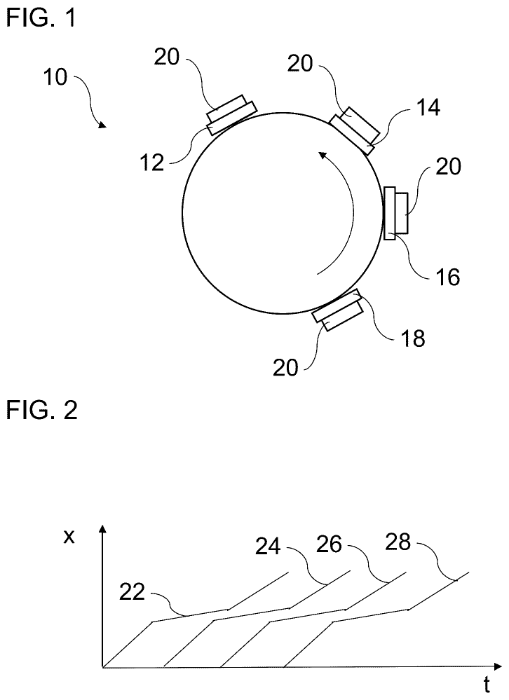

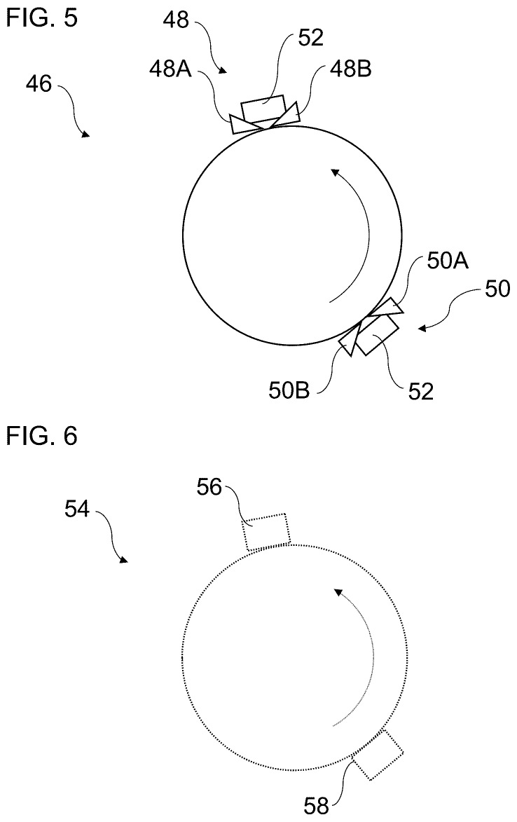

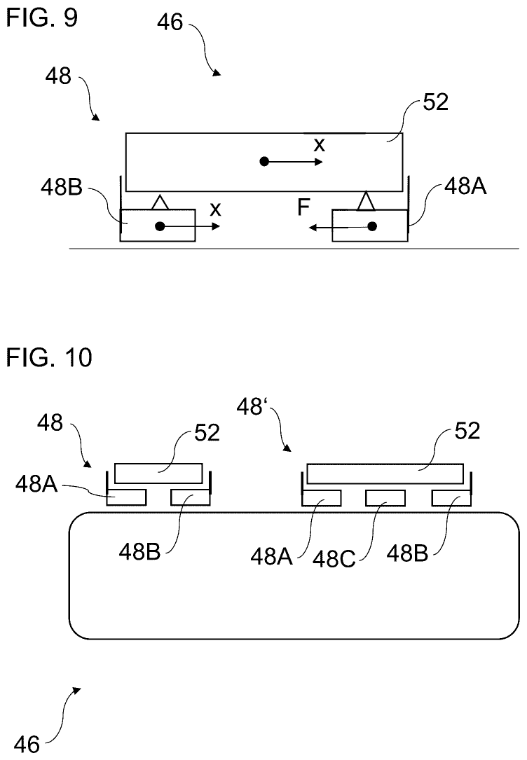

FIGS. 1 to 4 are first explained in more detail below. Building on this, FIGS. 5 to 8 are then described in more detail and illustrate an exemplary embodiment of the present disclosure. Finally, various modification examples are described with reference to FIGS. 9 and 10.

FIG. 1 shows a linear electric drive conveyor 10 having multiple moving devices 12, 14, 16, 18. In order to simplify the illustration, no takeover areas for taking over the transport items or payload units 20 onto the moving devices 12-18, no transfer areas for transferring the transport items 20 from the moving devices 12-18, no optional treatment stations along the conveyor 10 are shown, and also only four moving devices 12-18 are shown by way of example.

The moving devices 12-18 are controlled individually. Certain tasks can be performed with the moving devices 12-18. For example, the tasks are processed sequentially using individual moving devices 12-18 in each case. Each moving device 12-18 grasps a transport item 20, for example a container or multiple containers, and moves this transport item 20 as desired. Communication with an optional treatment station for the transport items 20 is required individually for each moving device 12-18. The control of the moving devices 12-18 is simple in that each moving device 12-18 has the same task. This means that only a single sequence or a single sequence structure needs to be configured.

For this purpose, FIG. 2 shows the respective movement paths 22-28 as examples. The movement paths 22-28 indicate a position x of the moving devices 12-18 along a static part of the conveyor 10 as a function of a time t. The moving device 12 is controlled according to the movement path 22. The moving device 14 is controlled according to the movement path 24. The moving device 16 is controlled according to the movement path 26. The moving device 18 is controlled according to the movement path 28. The movement paths 22-28 are essentially the same, but are offset in time from moving device to moving device.

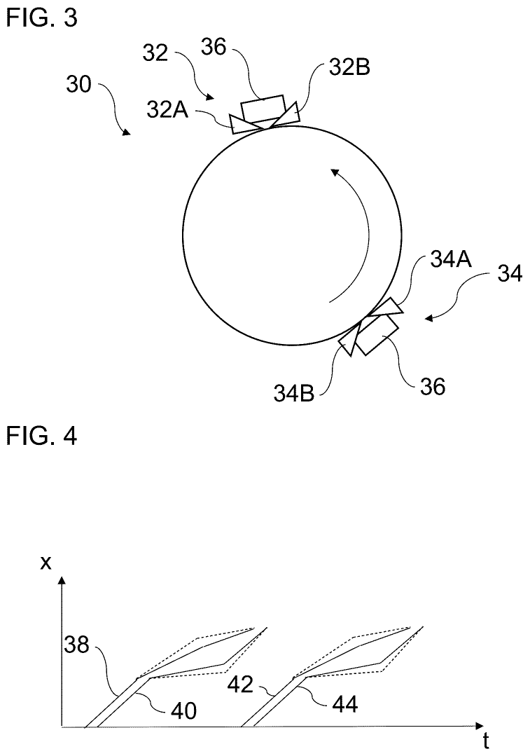

FIG. 3 shows a linear electric drive conveyor 30 with multiple moving devices 32A, 32B, 34A, 34B. In order to simplify the illustration, no takeover areas for taking over the transport items 36 onto the moving devices 32A, 32B, 34A, 34B, no transfer areas for transferring the transport items 36 from the moving devices 32A, 32B, 34A, 34B, no optional treatment stations along the conveyor 30 are shown, inter alia, and also only four moving devices 32A, 32B, 34A, 34B are shown by way of example.

The moving devices 32A and 32B are combined into a first group 32 or form the first group 32. The moving devices 34A and 34B are combined into a second group 34 or form the second group 34. The moving devices 32A, 32B of the first group 32 have the task of jointly transporting a transport item 36. The moving devices 34A, 34B of the second group 34 have the task of jointly transporting a further transport item 36.

To control the moving devices 32A, 32B, 34A, 34B, it is now possible to create different sequences or movement paths for the different moving devices 32A, 32B, 34A, 34B. These would then have to be completely revised for transport items 36 of different sizes.

For this purpose, FIG. 4 shows the respective movement paths 38-44 as examples. The movement paths 38-44 indicate a position x of the moving devices 32A, 32B, 34A, 34B along a static part of the conveyor 30 as a function of a time t. The first moving device 32A of the first group 32 is controlled according to the movement path 38. The second moving device 32B of the first group 32 is controlled according to the second movement path 40. The first moving device 34A of the second group 34 is controlled according to the movement path 42. The second moving device 34B of the second group 34 is controlled according to the movement path 44.

The movement paths 38-44 differ from each other. The movement paths 38 and 40 as well as 42 and 44 also have to be adjusted to each other in a complex manner in order to enable the respective transport item 36 to be clamped between them during the takeover of the transport item, joint transport of the respective transport item 36 and release of the respective transport item 36 clamped between them at the end of the transport. If the linear electric drive conveyor 30 were now to be operable with transport items 36 of different sizes, the control effort may increase many times over, since the movement paths 38-44 must be created separately for each transport item format (indicated in FIG. 4 by the dashed lines).

With reference to FIGS. 5 to 8, a control concept according to an exemplary embodiment of the present disclosure is described below, which can overcome the above-mentioned disadvantages.

FIG. 5 shows a linear electric drive conveyor 46 with multiple moving devices 48A, 48B, 50A, 50B. In order to simplify the illustration, no takeover areas for taking over the transport items 52 onto the moving devices 48A, 48B, 50A, 50B, no transfer areas for transferring the transport items 52 from the moving devices 48A, 48B, 50A, 50B, no optional treatment stations along the conveyor 46 are shown, inter alia, and also only four moving devices 48A, 48B, 50A, 50B are shown by way of example.

For example, the conveyor 46 may be included in an industrial system for transporting the transport items 52. The transport items 52 can each comprise one or more objects, preferably containers. Preferably, the conveyor 46 may be designed for transporting transport items 52 configured as containers. Particularly preferably, the conveyor 46 can be included in a container treatment system for treating containers, for example to transport the containers between container treatment devices of the container treatment system.

The moving devices 48A, 48B, 50A, 50B are electromagnetically movable. The moving devices 48A, 48B, 50A, 50B can be moved independently of one another. The moving devices 48A, 48B, 50A, 50B may be individually controllable by a control unit (not separately illustrated in FIG. 5) of the conveyor 46, for example directly or indirectly.

For example, the conveyor 46 can be a long-stator linear drive conveyor, a short-stator linear drive conveyor or a planar linear drive conveyor.

The long-stator or short-stator linear drive conveyor may have the multiple moving devices 48A, 48B, 50A, 50B, which are guided along a preferably circumferential guideway, for example by means of rollers or sliding shoes. The moving devices 48A, 48B, 50A, 50B can be driven by means of magnetic interaction between permanent magnets and electromagnets. The long-stator linear drive conveyor may include a stationary long stator with electromagnets for effecting a movement of the moving devices 48A, 48B, 50A, 50B equipped with permanent magnets. In the short-stator linear drive conveyor, on the other hand, the moving devices 48A, 48B, 50A, 50B can each comprise a short stator formed by electromagnets that can interact magnetically with stationary permanent magnets to move the moving devices 48A, 48B, 50A, 50B.

The planar linear drive conveyor or the planar motor linear drive conveyor can comprise the multiple moving devices 48A, 48B, 50A, 50B, which can be moved independently of one another with at least two degrees of freedom (x-direction and γ-direction) via a preferably planar drive surface by means of magnetic interaction with the drive surface. It is also possible that a lifting movement (z-direction) and/or a tilting movement of the moving devices 48A, 48B, 50A, 50B relative to the drive surface can also be controlled by means of the magnetic interaction. Preferably, the drive surface can be oriented horizontally or vertically.

The moving devices 48A and 48B are combined into a first group 48 or form the first group 48. The moving devices 48A, 48B of the first group 48 have the task of jointly transporting a transport item 52. Preferably, the moving devices 48A, 48B can clamp the transport item 52 between them for transportation. It is possible for the first group 48 consisting of the first moving device 48A and the second moving device 48B to be expanded by at least one further moving device (not shown in FIG. 5) in order to jointly transport the transport item 52.

The moving devices 50A and 50B are combined into a second group 50 or form the second group 50. The moving devices 50A, 50B of the second group 50 have the task of jointly transporting a further transport item 52. Preferably, the moving devices 50A, 50 can clamp the further transport item 52 between them for transportation. It is possible for the second group 50 consisting of the first moving device 50A and the second moving device 50B to be expanded by at least one further moving device (not shown in FIG. 5) in order to jointly transport the further transport item 52.

As mentioned, it is possible that the conveyor 46 has further groups of moving devices for transporting further transport items (not shown in FIG. 5).

FIG. 6 shows, purely schematically, a virtual model 54 that can be used to support control of the conveyor 46. The virtual model 54 can represent the conveyor 46 in an abstract manner. Preferably, the virtual model 54 abstracts the conveyor 46 in such a way that not every single real moving device 48A, 48B, 50A, 50B is modeled, but only the groups 48, 50 themselves. Accordingly, the virtual model 54 has a model object 56 which represents or models the first group 48, and a model object 58 which represents or models the second group 50, and optionally further model objects for further groups (not shown in FIG. 6).

The virtual model 54 can also be interpreted as follows. The model objects 56, 58 can be interpreted as virtual moving devices, each of which can individually move a transport item. One moving device is thus assigned to one transport item in each case. As explained, this is in contrast to the actual conveyor 46, in which at least two moving devices 48A, 48B and 50A, 50B each jointly move one transport item 52. The virtual model 54 can thus abstract the conveyor 46 from a real assignment, in which multiple moving devices 48A, 48B and 50A, 50B each jointly transport one transport item 52, to a simplified assignment, in which one moving device each transports one transport item. In other words, the virtual model 54 can act as if the conveyor 46 of FIG. 5 were designed like the conveyor 10 of FIG. 1.

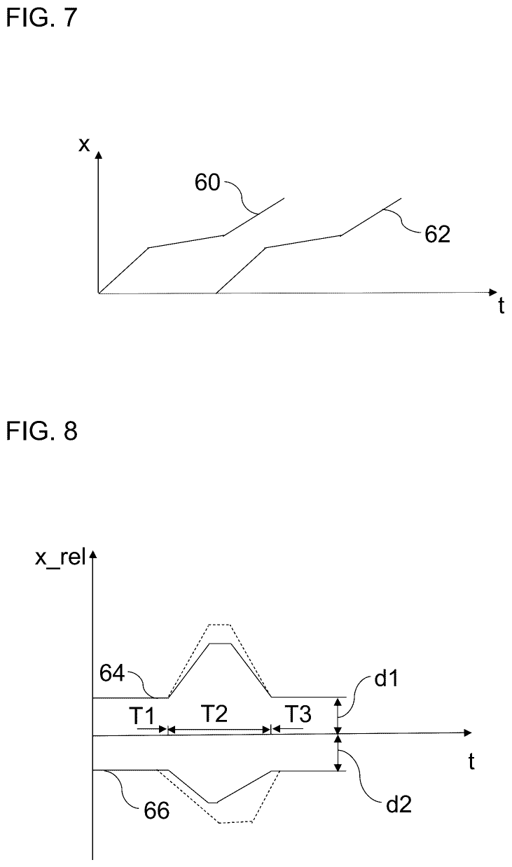

FIG. 7 shows that a virtual movement path 60, 62 can be created for each of the model objects 56, 58. The first virtual movement path 60 indicates a time-dependent position progression of the first model object 56 along the static part of the virtual model 54. The second virtual movement path 62 can indicate a time-dependent position progression of the second model object 56 along the static part of the virtual model 54. The static part of the virtual model 54 can, for example, represent or model a circumferential guideway, a long stator, a series of permanent magnets (e.g., in a short-stator drive) or a drive surface.

The virtual movement paths 60, 62 may preferably have at least one path section extending from a transport item takeover point for taking over the transport item to a transport item transfer point for transferring the transport item. Preferably, the virtual movement paths 60, 62 each have a further path section for returning the model object 56, 58 from the transport item transfer point to the transport item takeover point.

The virtual model 54 may represent a preferably uppermost functional level for controlling the conveyor 46. This uppermost functional level can form the interface to the outside within the control system, for example for synchronization with the transport items 52, the transfer conveyor (e.g., transfer starter), the treatment station, etc. The real conveyor 46 with its moving devices 48A, 48B, 50A, 50B can be located on an underlying functional level.

The (real) moving devices 48A, 48B, 50A, 50B are controlled according to the created virtual movement paths 60, 62. Preferably, the moving devices 48A, 48B, 50A, 50B synchronize with the virtual movement paths 60, 62 or the model objects 56, 58 and preferably move substantially synchronously therewith throughout the entire production.

Specifically, the first moving device 48A and the second moving device 48B of the first group 48 are controlled to move along a static part of the conveyor 46 according to the first virtual movement path 60 of the first model object 56. Preferably, the moving devices 48A, 48B may move in a coupled, preferably co-moving, manner with the first virtual movement path 60. For example, the static part of the conveyor 46 may have a circumferential guideway, a long stator, a series of permanent magnets (e.g., in a short stator drive), or a drive surface.

The first moving device 50A and the second moving device 50B of the second group 50 are controlled to move along the static part of the conveyor 46 according to the second virtual movement path 62 of the second model object 58. Preferably, the moving devices 50A, 50B may move in a coupled, preferably co-moving, manner with the second virtual movement path 62.

FIG. 8 shows in detail by way of example how the dependency of the control of the moving devices 48A, 48B on the created virtual movement path 60 can be implemented.

FIG. 8 shows relative movement paths 64, 66. The first movement path 64 may indicate a progression of a relative position x_rel of the first moving device 48A relative to the first virtual movement path 60 (or the first model object 56) as a function of time t. The second movement path 66 may indicate a progression of a relative position x_rel of the second moving device 48B relative to the first virtual movement path 60 (or the first model object 56) as a function of time t.

Preferably, the moving devices 48A, 48B can at least temporarily move synchronously with the first virtual movement path 60. This is schematically illustrated in FIG. 8 in the time periods T1 and T3.

As can be seen from the relative movement path 64, the first moving device 48A can be controlled at least temporarily to move synchronously at a first distance d1 from the first virtual movement path 60. Preferably, the first moving device 48A precedes the first virtual movement path 60 by the first distance d1. As can be seen from the relative movement path 66, the second moving device 48B can in turn be controlled, at least temporarily, to move synchronously at a second distance d2 from the first virtual movement path 60. Preferably, the second moving device 48B follows the first virtual movement path 60 by the second distance d2.

The first distance d1 and/or the second distance d2 can be specified. Preferably, the first distance d1 and/or the second distance d2 can be entered by means of a user interface (not shown separately) of the conveyor 46.

Preferably, the first distance d1 and/or the second distance d2 can be specified depending on a size of the transport item 52. The larger the transport item 52, the larger the specified first distance d1 and/or the second distance d2 can be. If the first moving device 48A moves in advance of the first virtual movement path 60 and the second moving device 48B follows the first virtual movement path, a sum of the first distance d1 and the second distance d2 can preferably correspond substantially to a width or a diameter of the transport item 52.

This control system can thus be adjusted in a particularly simple manner when a change in the transport item format, preferably container format, takes place. For example, the transport item 52 can be selected from multiple transport items of different sizes and the first distance d1 and/or the second distance d2 can be specified depending on a size of the selected transport item 52. If at another time a larger or smaller transport item 52 is selected from the multiple transport items of different sizes, the distances d1 and/or d2 can be easily adjusted to this selected transport item 52. An adjustment of the first distance d1 and/or the second distance d2 has no effect on the first virtual movement path 60 or on a movement of the first model object 56.

The first moving device 48A and the second moving device 48B of the first group 48 (and optionally of each further group) can move relative to each other during the coupling, preferably the co-movement, with the virtual movement path 60. In this way, for example, different functions can be fulfilled.

For example, the moving devices 48A, 48B can be controlled so that they move relative to each other, for example in order to clamp or hold the transport item 52 between them. Preferably, the first moving device 48A may move relative to the second moving device 48B to cover the first distance d1, and/or the second moving device 48B may move relative to the first moving device 48A to cover the second distance d2. This can be done, for example, by temporarily accelerating the second moving device 48B and/or temporarily decelerating the first moving device 48A.

In another example, the moving devices 48A, 48B can be controlled so that they move away from each other relatively, for example in order to release the transport item 52 clamped or held between them. Preferably, the first moving device 48A can move relatively away from the second moving device 48B starting from the first distance d1, and/or the second moving device 48B can move relatively away from the first moving device 48A starting from the second distance d2. This can be done, for example, by temporarily accelerating the first moving device 48A and/or temporarily decelerating the second moving device 48B.

Specifically, special functions such as clamping, holding, releasing a transport item 52 may be implemented as an override of the coupling, in which the moving devices 48A and 48B are coupled to the first virtual movement path 60 or the first model object by means of the distances d1, d2. This is illustrated, for example, in FIG. 8 in time period T2. As can be understood from the relative movement paths 64, 66 in FIG. 8, the moving devices 48A and 48A initially increase their distance from the first virtual movement path 60 or from the first model object 56 in the time period T2, starting from the distances d1, d2. Later in the time period T2, the moving devices 48A and 48B again reduce their distances from the first virtual movement path 60 and the first model object 56 to the distances d1 and d2. For example, in the time period T2, a transport item 52 could be released and a further transport item 52 could then be clamped or held. In the time period T2, the first distance d1 and/or the second distance d2 can therefore be overridden with the corresponding function for relative movement. The dashed lines in time period T2 are intended to illustrate that any functions for moving the moving devices 48A and 48B relative to each other can be implemented.

In terms of control technology, the temporary override of the first distance d1 and/or of the second distance d2 can, for example, be implemented such that the temporary override is dependent on a variable parameter value of the model object 56. The parameter value may preferably be a size parameter value that specifies a virtual size of the model object 56. As long as the parameter value is constant, the distances d1 and d2, for example, can be maintained. To increase a distance between the moving devices 48A and 48B, the parameter value can be increased, for example to release a transport item 52. To reduce a distance between the moving devices 48A and 48B, the parameter value can be reduced, for example to clamp the transport item 52.

FIG. 9 shows a modified exemplary embodiment.

In this case, for example, the second moving device 48B can be moved fixedly coupled to the first virtual movement path 60 or the first model object 56. The first moving device 48A, in turn, can be temporarily moved in a force-controlled manner in order to clamp the transport item 52 between the moving devices 48A and 48B. The roles of the first moving device 48A and the second moving device 48B can also be swapped.

In terms of control technology, this can be implemented in such a way that the second distance d2 (or the first distance d1) is set to a constant value. The first distance d1 (or the second distance d2), however, can be temporarily controlled to produce a force-controlled movement against the transport item 52 or against the first moving device 48A (or the second moving device 48B), such that the transport item 52 can preferably be clamped between the moving devices 48A and 48B.

FIG. 10 shows purely by way of example that the control concept of the present disclosure is not only applicable to groups of two moving devices 48A, 48B in each case. Instead, the control concept can be applied to groups of any number of moving devices, for example to groups of three moving devices 48A, 48B, 48C in each case.

Accordingly, the third moving device 48C, like the first and second moving devices 48A, 48B, of the group 48′ can be controlled in order to move along the static part of the conveyor 46 according to, preferably coupled or co-moving with, the first virtual movement path 60 of the first model object 56, and so on.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the sub-claims are also disclosed independently of all the features of independent claim 1.

List of Reference Signs

| | |
|---|---|
| 10 | linear electric drive conveyor |
| 12 | moving device |
| 14 | moving device |
| 16 | moving device |
| 18 | moving device |
| 20 | transport item |
| 22 | movement path |
| 24 | movement path |
| 26 | movement path |
| 28 | movement path |
| 30 | linear electric drive conveyor |
| 32 | first group |
| 32A | first moving device |
| 32B | second moving device |
| 34 | second transport device |
| 34A | first moving device |
| 34B | second moving device |
| 36 | transport item |
| 38 | movement path |
| 40 | movement path |
| 42 | movement path |
| 44 | movement path |
| 46 | linear electric drive conveyor |
| 48 | first group |
| 48A | first moving device |
| 48B | second moving device |
| 48C | third moving device |
| 50 | second group |
| 50A | first moving device |
| 50B | second moving device |
| 52 | transport item |
| 54 | virtual model |
| 56 | first model object |
| 58 | second model object |
| 60 | first virtual movement path |
| 62 | second virtual movement path |
| 64 | relative movement path |
| 66 | relative movement path |
| d1 | first distance |
| d2 | second distance |
| T1 | first time period |
| T2 | second time period |
| T3 | third time period |

1. A method for operating a linear electric drive conveyor-having multiple electromagnetically and independently movable moving devices which are combined into multiple groups, wherein the multiple moving devices are movable in each group in order to jointly transport a transport item, wherein the method comprises:
creating a virtual movement path for each model object in a virtual model (54) that represents the linear electric drive conveyor, wherein in the virtual model each group is represented by a model object and the created virtual movement paths each indicate a time-dependent position progression of the respective model object along a static part of the virtual model; and
controlling the linear electric drive conveyor in order to move a first moving device and a second moving device, per group, along a static part of the linear electric drive conveyor according to the virtual movement path of the model object that represents the respective group.

2. The method according to claim 1, wherein at least one of:
the linear electric drive conveyor is controlled in such a way that the first moving device for each group moves synchronously at least temporarily at a first distance from the virtual movement path of the model object representing the respective group; and
the linear electric drive conveyor is controlled in such a way that the second moving device for each group moves synchronously at least temporarily at a second distance from the virtual movement path of the model object representing the respective group.

3. The method according to claim 2, further comprising:
specifying at least one of the first distance and/or the second distance via a user interface.

4. The method according to claim 3, wherein:
at least one of the first distance and the second distance is specified depending on a size of the transport item.

5. The method according to claim 3, further comprising:
selecting the transport item from a selection of transport items of different sizes,
wherein at least one of the first distance and/or the second distance is specified depending on a size of the selected transport item.

6. The method according to claim 2, further comprising:
changing at least one of the first distance and the second distance when at least one of changing the transport item format and the container format.

7. The method according to claim 2, further comprising:
temporarily overriding at least one of the first distance and the second distance in order to effect a relative movement between the first moving device and the second moving device per group.

8. The method according to claim 7, wherein:
the temporary overriding of at least one of the first distance and/or of the second distance is dependent on a variable parameter value of the model object that represents the respective group.

9. The method according to claim 2, further comprising:
setting one of the first distance and the second distance to a constant value; and
temporarily overriding the other one of the first distance and the second distance with a force-controlled movement of the respective moving device in order to clamp the transport item between the first moving device and the second moving device.

10. The method according to claim 1, wherein:
the linear electric drive conveyor is controlled in such a way that the first moving device and the second moving device, per group, move along the static part of the linear electric drive conveyor at least temporarily while performing a relative movement to one another for at least one of clamping, holding and/or releasing the transport item with the virtual movement path of the model object that represents the respective group.

11. The method according to claim 1, further comprising:
controlling the linear electric drive conveyor in order to move a third moving device, per group, along a static part of the linear electric drive conveyor according to the virtual movement path of the model object that represents the respective group.

12. The method according to claim 1, wherein:
the virtual movement path has, for each model object, a path section which extends from a transport item takeover point for taking over the transport item to a transport item transfer point for transferring the transport item.

13. The method according to claim 1, wherein:
the linear electric drive conveyor includes one of a long-stator linear drive conveyor, a short-stator linear drive conveyor, and a planar linear drive conveyor.

14. A linear electric drive conveyor for an industrial system, wherein the linear electric drive conveyor comprises:
multiple electromagnetically and independently movable moving devices which are combined into multiple groups, wherein the multiple moving devices are movable in each group in order to jointly transport a transport item which is one of clamped between them and jointly held; and
a control unit configured to carry out a method according to claim 1.

15. An industrial system, comprising:
a linear electric drive conveyor according to claim 14.

16. The method according to claim 1, wherein the first moving device and the second moving device, per group, are one of coupled and comoving with the virtual movement path of the model object that represents the respective group.

17. The method according to claim 2, wherein at least one of:
the first moving device for each group moves in advance at the first distance from the virtual movement path of the model object representing the respective group; and
the second moving device for each group follows in movement at the second distance from the virtual movement path of the model object representing the respective group.

18. The method according to claim 4, wherein at least one of:
the larger the transport item, the larger at least one of the specified first distance and the second distance; and
a sum of the first distance and the second distance one of substantially corresponds to a width of the transport item and substantially corresponds to a diameter of the transport item.

19. The method according to claim 7, wherein the temporarily overriding of at least one of the first distance and the second distance in order to effect a relative movement between the first moving device and the second moving device per group is in order to at least one of take over the transport item, hold the transport item, clamp the transport item, transfer the transport item and release the transport item.

20. The method according to claim 8, wherein at least one of:
the variable parameter value is a size parameter value;
the variable parameter value is greater before the transport item is clamped than when it is clamped;
the variable parameter value is reduced to clamp the transport item;
the variable parameter value is increased to release the transport item; and
the variable parameter value is greater when the transport item is being released than when it is being clamped.
